(19) United States
(12) Patent Application Publication
(10) Pub. No.: US 2021/0098843 A1
(43) Pub. Date: Apr. 1, 2021

(54) METAL-AIR BATTERY AND METHOD FOR MANUFACTURING METAL-AIR BATTERY

(71) Applicant: SHARP KABUSHIKI KAISHA, Sakai City, Osaka (JP)

(72) Inventors: HIROTAKA MIZUHATA, Sakai City, Osaka (JP); AKIHITO YOSHIDA, Sakai City, Osaka (JP); TOMO KITAGAWA, Sakai City, Osaka (JP); TOMOHISA YOSHIE, Sakai City, Osaka (JP); ATSUSHI FUKUI, Sakai City, Osaka (JP)

(21) Appl. No.: 17/044,703

(22) PCT Filed: Apr. 11, 2019
(86) PCT No.: PCT/JP2019/015845

§ 371 Date: Oct. 1, 2020

(30) Foreign Application Priority Data
Apr. 18, 2018 (JP) 2018-079722

(51) Int. Cl. H01M 12/06; H01M 12/08; H01M 50/121; H01M 50/183; H01M 50/543; H01M 4/62; H01M 50/533

(52) U.S. Cl. CPC H01M 12/06; H01M 12/08; H01M 50/121; H01M 2250/30; H01M 50/543; H01M 4/628; H01M 50/533; H01M 50/183

(57) ABSTRACT

A metal-air battery comprises a casing including a first surface having breathability and second surface different from the first surface; and a positive electrode housed in the casing, a negative electrode housed in the casing, a positive-electrode terminal electrically connected to the positive electrode and exposed from the casing, a negative-electrode terminal electrically connected to the negative electrode and exposed from the casing, and an adhesive layer containing an adhesive and provided on a portion of the second surface.

### TECHNICAL FIELD

The present disclosure relates to a metal-air battery and a method for manufacturing the metal-air battery.

### BACKGROUND ART

Metal-air batteries include an air electrode (positive electrode), a metal negative electrode (negative electrode), and an electrolytic layer (electrolytic solution).

Patent Literature 1 discloses a laminated metal-air battery that includes a laminate film, which is a sheathing material, covering a power generation component including a positive electrode, negative electrode and electrolytic layer.

### CITATION LIST

### Patent Literature

Patent Literature 1: International Publication No. 2017/002815

### SUMMARY OF INVENTION

### Technical Problem

A conventional laminated metal-air battery has a positive-electrode terminal electrically connected to the positive electrode and a negative-electrode terminal electrically connected to the negative electrode. These electrodes protrude from a casing (sheathing cover) consisting of a laminate film. Such a structure, where the positive-electrode terminal and the negative-electrode terminal protrude from the casing, requires these terminals to be soldered or welded to a terminal of a target object, such as an electric device, because there is no intervention for joining the battery and the target object together. In addition, the positive-electrode terminal and the negative-electrode terminal are exposed even after the battery is attached to the target object; hence, a conductor can accidentally come into contact between the terminals, thus developing a short circuit.

To solve the above problems, it is an object of the present disclosure to provide a metal-air battery that can be attached to a target object easily without soldering or welding and has a structure less likely to develop a short circuit after the attachment.

### Solution to Problem

To solve the above problems, one aspect of the present disclosure provides a metal-air battery that includes a casing, and positive and negative electrodes housed in the casing. The casing includes a first surface having breathability, and a second surface different from the first surface. The casing incorporates a positive-electrode terminal electrically connected to the positive electrode, and a negative-electrode terminal electrically connected to the negative electrode. The positive-electrode terminal and the negative-electrode terminal are disposed in a location where the positive-electrode terminal and the negative-electrode terminal do not overlap each other when viewed from the second surface. The second surface has a first opening disposed in a location corresponding to the positive-electrode terminal, and a second opening disposed in a location corresponding to the negative-electrode terminal. At least part of a surface of the second surface except the first and second openings is provided with an adhesive layer containing an adhesive.

Herein, the positive electrode may be adjacent to the first surface within the casing. The negative electrode may be adjacent to the second surface within the casing. The metal-air battery may further include an electrolytic layer between the positive and negative electrodes. The electrolytic layer contains an electrolyte.

Herein, the casing may include a first resin sheet including the first surface, and a second resin sheet including the second surface and joined to the first resin sheet.

Herein, the negative electrode may have a negative-electrode current collector stacked on the second resin sheet, and a negative-electrode active material layer stacked on the negative-electrode current collector and containing a negative-electrode active material. The negative-electrode current collector may include a negative-electrode lead composed of part of the negative-electrode current collector extending to form the negative-electrode terminal.

Herein, the electrolytic layer may cover the edge of the negative-electrode active material.

Herein, the positive electrode may have a positive-electrode catalyst layer stacked on the electrolytic layer and containing a catalyst capable of oxygen reduction, and a positive-electrode current collector stacked on the positive-electrode catalyst layer. The positive-electrode current collector may include a negative-electrode lead composed of part of the positive-electrode current collector extending to form the positive-electrode terminal.

Herein, the first resin sheet may have a third opening. The positive electrode may include a water-repellent film stacked on the positive-electrode current collector and sealing the third opening from the inside of the third opening.

Herein, the metal-air battery may further include the following: a positive-electrode lead composed of part of the positive electrode extending to form the positive-electrode terminal; a negative-electrode lead composed of part of the negative electrode extending to form the negative-electrode terminal; and an insulating tape disposed between the first resin film and the negative-electrode lead, between the second resin film and the positive-electrode lead, and between the positive-electrode lead and the negative-electrode lead.

Herein, the first surface may have a surface on which a protective layer having no breathability is disposed in a peelable manner.

Herein, the adhesive layer on the surface of the second surface may have a surface on which a protective layer having no adhesion is disposed in a peelable manner.

Herein, at least part of the first surface may be made of porous insulating material.

Herein, the first and second openings may incorporate a conductive adhesive layer.

Herein, the first surface may be provided with a character or picture displayed.

Herein, the picture may be a bar code or a two-dimensional code.

An aspect of the present disclosure provides a method for manufacturing a metal-air battery. The method includes the following: a first step of stacking a positive-electrode layer having a portion to be a positive-electrode terminal onto a first resin sheet having breathability; a second step of stacking a negative-electrode layer having a portion to be a negative-electrode terminal onto a second resin sheet different from the first resin sheet; a third step of joining together the first and second resin sheets with the positive-electrode layer on the first resin sheet and the negative-electrode layer on the second resin sheet facing each other via an electrolytic layer; and a fourth step of stacking an adhesive layer onto a surface of the second resin sheet where the negative-electrode layer is not stacked. The portion to be the positive-electrode terminal and the portion to be the negative-electrode terminal are disposed in a location where the portion to be the positive-electrode terminal and the portion to be the negative-electrode terminal do not overlap each other when viewed from the second resin sheet. The second resin sheet has a first opening disposed in a location corresponding to the portion to be the positive-electrode terminal, and a second opening disposed in a location corresponding to the portion to be the negative-electrode terminal.

### Advantageous Effect of Invention

According to the present disclosure, only joining the joint surface (i.e., the second surface) to a target object with the terminals (i.e., the positive-electrode terminal and the negative-electrode terminal), which are exposed from the two openings (i.e., the first and second openings) of the joint surface, facing a terminal of the target object can establish electrical conduction with the target object. In addition, the joint surface, which is provided with the adhesive layer, is easily attached to the target object without soldering, welding, or other joining methods. In addition, the positive-electrode terminal and the negative-electrode terminal are not exposed from a surface opposite to the joint surface. This prevents a possible short circuit caused by accidental contact after the attachment.

### BRIEF DESCRIPTION OF DRAWINGS

FIG. 1(a) is an external perspective view of a metal-air battery 1 according to a first embodiment viewed from its first surface. FIG. 1(b) is an external perspective view of the metal-air battery 1 according to the first embodiment viewed from its second surface.

FIG. 2(a) is a cross-sectional view of the metal-air battery 1 taken along line A-A′. FIG. 2(b) is a cross-sectional view of the metal-air battery 1 taken along line B-B′. FIG. 2(c) is a cross-sectional view of the metal-air battery 1 taken along line C-C′. FIG. 2(d) is a front view of the second surface of the metal-air battery 1.

FIG. 3(a) is an exploded perspective view of the metal-air battery 1 broken down into components. FIG. 3(b) is a developed view of the components of the metal-air battery 1.

FIG. 4 is an example flowchart showing process steps for manufacturing the metal-air battery 1.

FIG. 5 is a schematic view of the metal-air battery 1 under manufacture.

FIG. 6 is a schematic view of the metal-air battery 1 under manufacture.

FIG. 7 is a schematic view of the metal-air battery 1 under manufacture.

FIG. 8 is a schematic view of the metal-air battery 1 under manufacture.

FIG. 9 is a schematic view of the metal-air battery 1 under manufacture.

FIG. 10(a) is a cross-sectional view of a metal-air battery 2 taken along line A-A′. FIG. 10(b) is a cross-sectional view of the metal-air battery 2 taken along line B-B′. FIG. 10(c) is a cross-sectional view of the metal-air battery 2 taken along line C-C′. FIG. 2(d) is a front view of the second surface of the metal-air battery 2.

FIG. 11 is an example flowchart showing process steps for manufacturing the metal-air battery 2.

FIG. 12(a) is a cross-sectional view of a metal-air battery 3 taken along line A-A′. FIG. 12(b) is a cross-sectional view of the metal-air battery 3 taken along line B-B′. FIG. 12(c) is a cross-sectional view of the metal-air battery 3 taken along line C-C′. FIG. 12(d) is a front view of the second surface of the metal-air battery 3.

FIG. 13 is a plan view of a positive-electrode current collector, negative-electrode current collector and insulating tape extracted from a metal-air battery 4 and viewed from the positive-electrode current collector.

FIG. 14 is a cross-sectional view of the metal-air battery 4 along the longer-side direction of the insulating tape.

FIG. 15 is a schematic view of an example first surface of a metal-air battery.

FIG. 16 is a schematic view of an example usage of the metal-air battery.

### DESCRIPTION OF EMBODIMENTS

### 1. First Embodiment

A metal-air battery 1 according to a first embodiment of the present disclosure and a method for manufacturing the metal-air battery 1 will be described with reference to the drawings.

### 1.1. Configuration of Metal-Air Battery 1

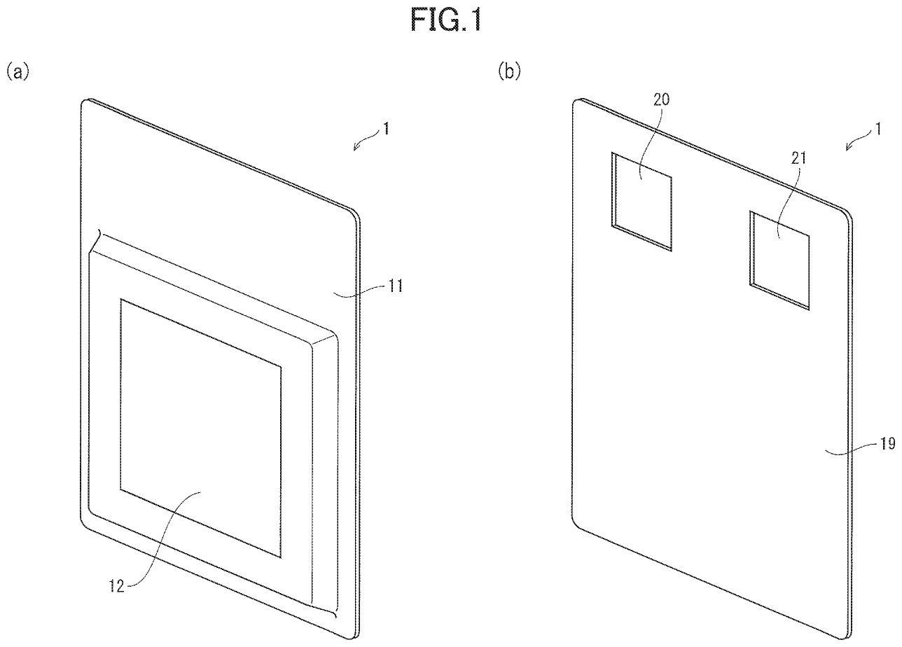

FIG. 1 is an external perspective view of the metal-air battery 1 according to the first embodiment of the present disclosure. FIG. 1(a) illustrates a first surface of the metal-air battery 1; and FIG. 1(b), a second surface of the metal-air battery 1.

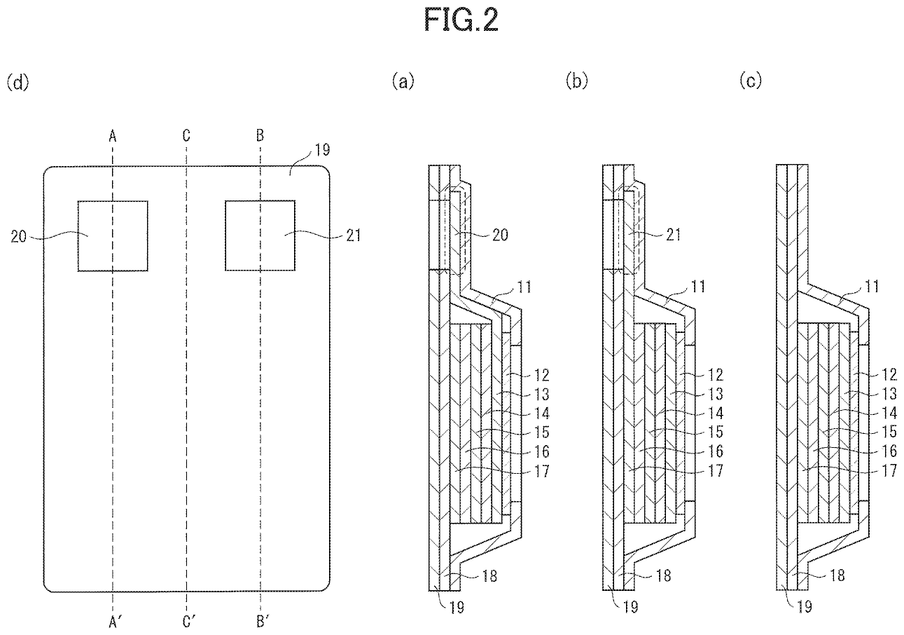

FIG. 2(a) is a cross-sectional view taken along line A-A′ in FIG. 2(d); FIG. 2(b), a cross-sectional view taken along line B-B′ in FIG. 2(d); FIG. 2(c), a cross-sectional view taken along line C-C′ in FIG. 2(d); and FIG. 2(d), a front view of the second surface of the metal-air battery 1.

As illustrated in FIGS. 1(a) and (b), and FIG. 2(d), together with the first and second surfaces, the metal-air battery 1 is in the form of a plate having a substantially rectangular shape.

The first surface of the metal-air battery 1 is composed of a laminate material 11 having an opening, from which a water-repellent film 12 is exposed. The second surface of the metal-air battery 1 is composed of an adhesive layer 19 disposed on a surface of a laminate material 18 having two openings, from one of which a positive-electrode terminal 20 is exposed and from the other of which a negative-electrode terminal 21 is exposed. The metal-air battery 1 has a casing composed of the laminate materials 11 and 18.

As illustrated in FIGS. 2(a), (b) and (c), the metal-air battery 1 has a stacked structure of, in sequence, the laminate material 11, the water-repellent film 12, a positive-electrode current collector 13, a positive-electrode catalyst layer 14, a separator (electrolytic layer) 15, a negative-electrode active material layer 16, a negative-electrode current collector 17, the laminate material 18, and the adhesive layer 19.

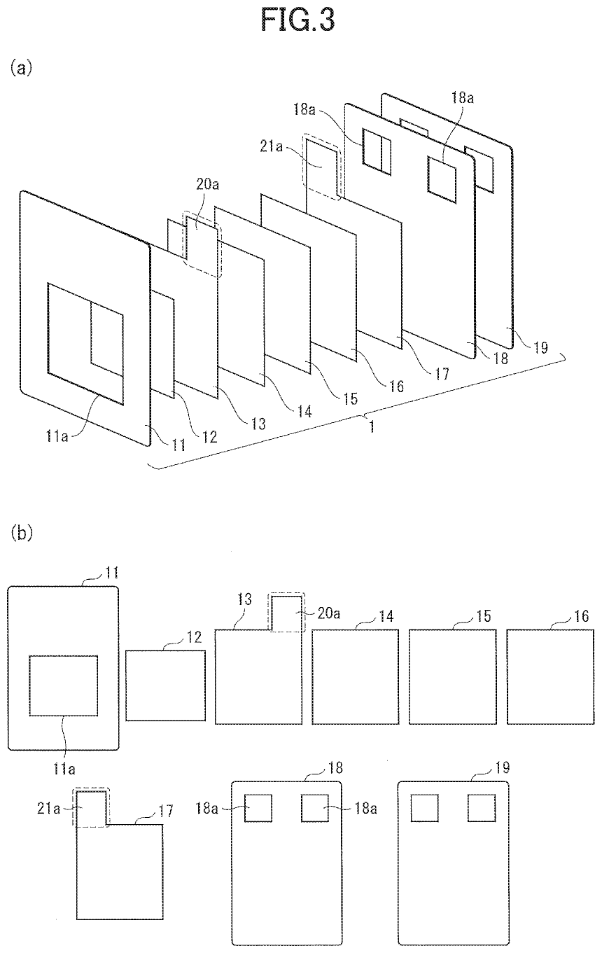

FIG. 3(a) is an exploded perspective view of the metal-air battery 1 broken down into components. FIG. 3(b) is a developed view of the components of the metal-air battery 1.

### (1) Laminate Material 11

The laminate material 11 is a substantially rectangular thin film, the inside of which is provided with a substantially rectangular opening 11a.

### (2) Water-Repellent Film 12

The water-repellent film 12 is a substantially rectangular thin film made of porous material containing water-repellent resin. The water-repellent film 12 has a size larger than that of the opening lla of the laminate material 11 and smaller than that of the entire laminate material 11. The water-repellent film 12 is placed on the laminate material 11 so as to cover the opening 11a of the laminate material 11 from the inside of the metal-air battery 1, and is thermally welded to the laminate material 11 around the opening.

### (3) Positive-Electrode Current Collector 13

The positive-electrode current collector 13 is a substantially rectangular plate made of porous and electron-conductive material. The positive-electrode current collector 13 has a size equal to or larger than that of the water-repellent film 12.

As illustrated in FIGS. 3(a) and (b), part of the positive-electrode current collector 13 extends upward in the drawings to form a positive-electrode lead 20a. The positive-electrode lead 20a has a substantially rectangular shape. The positive-electrode lead 20a has a size substantially equal to but slightly larger than that of an opening 18a of the laminate material 18, from which a portion of the positive-electrode lead 20a is exposed, thus forming the positive-electrode terminal 20. The positive-electrode terminal 20 is disposed in a location that does not overlap the negative-electrode terminal 21 when viewed from the second surface.

### (4) Positive-Electrode Catalyst Layer 14

The positive-electrode catalyst layer 14 has a substantially rectangular shape made of material containing a conductive porous support and a catalyst supported by the porous support. On the catalyst included in the positive-electrode catalyst layer 14 is formed a three-phase interface where water, an oxygen gas, and electrons coexist, thus progressing a discharge reaction or a charge and discharge reaction. Here, when the metal-air battery 1 is a primary battery, the catalyst is an oxygen-reduction catalyst, progressing a discharge reaction at the three-phase interface. When the metal-air battery 1 is a secondary battery, the catalyst is an oxygen-reduction catalyst as well as an oxygen-evolution catalyst, progressing a charge and discharge reaction at the three-phase interface.

### (5) Separator 15

The separator 15 is a substantially rectangular thin film. The separator 15 enables charge carriers to move between the positive electrode (positive-electrode catalyst layer 14) and the negative electrode (negative-electrode active material layer 16) while establishing insulation between these components. The separator 15 has a size larger than those of the positive-electrode catalyst layer 14 and negative-electrode active material layer 16. The separator 15 may be provided so as to cover the periphery of the positive-electrode catalyst layer 14 or the periphery of the negative-electrode active material layer 14.

### (6) Negative-Electrode Active Material Layer 16

The negative-electrode active material layer 16 is an electrode made of active material (negative-electrode active material) containing a metal element, and has a substantially rectangular shape.

### (7) Negative-Electrode Current Collector 17

The negative-electrode current collector 17 is a substantially rectangular plate made of porous material. As illustrated in FIGS. 3(a) and (b), part of the negative-electrode current collector 17 extends upward in the drawings to form a negative-electrode lead 21a. The negative-electrode lead 21a has a substantially rectangular shape. The negative-electrode lead 21a has a size substantially equal to but slightly larger than that of another opening 18a of the laminate material 18, from which a portion of the negative-electrode lead 21a is exposed, thus forming the negative-electrode terminal 21. The negative-electrode terminal 21 is disposed in a location that does not overlap the positive-electrode terminal 20 when viewed from the second surface.

### (8) Laminate Material 18

The laminate material 18 is a substantially rectangular thin film, the inside of which is provided with two substantially rectangular openings. Exposed from one of the two openings is the positive-electrode terminal 20, and exposed from the other is the negative-electrode terminal 21.

### (9) Adhesive Layer 19

The adhesive layer 19 is disposed on a surface of the laminate material 18 and is a layer to adhere to a target object, such as an electric device. clp 1.2. Materials of Metal-Air Battery 1

Although each component of the metal-air battery 1 may be made of any material that is commonly used in the field, the following describes example materials of the components.

### (1) Laminate Materials 11 and 18

The laminate materials 11 and 18 are preferably made of material having corrosion-resistance against an electrolytic solution, and having heat-resistance and thermal weldability. A usable example of the material is a layer of polyethylene terephthalate or nylon covered with a layer of polypropylene or polyethylene serving as a thermal-welding layer. Polyethylene terephthalate and nylon function as a heat-resistant base material and maintain shape at the time of thermal welding. To prevent self-corrosion resulting from oxygen diffusion into the battery inside, such a layer of heat-resistant base material is preferably polyethylene terephthalate, which has a high capability of gas blockage. Moreover, to enhance the capability of gas blockage, an aluminum layer may be vapor-deposited.

In some embodiments, the laminate materials 11 and 18 may be provided using the same material or different materials.

### (2) Water-Repellent Film 12

To avoid moisture leakage from the electrolytic layer (separator 15), the water-repellent film 12 is preferably made of porous material having water repellency. For instance, porous polypropylene, porous Teflon (registered trademark), or other materials may be used. Moreover, a combination of the material of the laminate material 11 and 18 and these porous materials may be used.

### (3) Positive-Electrode Current Collector 13

The positive-electrode current collector 13 is desirably made of porous and electron-conductive material. When an alkaline aqueous solution is used as the electrolytic solution, a metal material (e.g., nickel or stainless steel) having a nickel-plated surface is desirably used in view of corrosion resistance. Using mesh (e.g., a metal fiber textile), expanded metal, perforated metal, etched metal, a sintered compact of metal particles or metal fibers, a metal foam, or other materials enables the positive-electrode current collector 13 to be porous.

### (4) Positive-Electrode Catalyst Layer 14

The positive-electrode catalyst layer 14 may be made of carbon, manganese dioxide, and polytetrafluoroethylene. Instead of the polytetrafluoroethylene, a hydrophilic polymer, including an anion-exchanging polymer and polyacrylic acid, may be used.

### (5) Separator 15

The separator 15 may be made of anion-exchanging resin or hydrous gel (cross-linked polyacrylic gel) that can contain an electrolyte, or may be composed of a layer of, for instance, porous polypropylene or vinylon containing an electrolyte. Examples of the electrolyte (electrolytic solution) usable herein include an alkaline aqueous solution of, for instance, potassium hydroxide or potassium carbonate, and an aqueous solution containing ammonium chloride. For safety reasons, an aqueous solution containing ammonium chloride, which is not alkaline, is desirably used.

### (6) Negative-Electrode Active Material Layer 16

The negative-electrode active material layer 16 may be made of zinc (zinc powders) and anion-exchanging polymer. Instead of the zinc, alloy particles of zinc and another element (e.g., bismuth, indium, or aluminum) may be used. Instead of the anion-exchanging polymer, a hydrophilic polymer, such as polyacrylic acid, may be used.

### (7) Negative-Electrode Current Collector 17

The positive-electrode current collector 17 is desirably made of porous and electron-conductive material. To prevent self-corrosion, the negative-electrode current collector 17 is desirably made of material having high hydrogen overvoltage, or of metal material (e.g., stainless steel) having a surface plated with a material having high hydrogen overvoltage.

When zinc is used as the negative-electrode active material, copper foil, brass, tin-plated copper foil, or other materials is desirably used.

### (8) Adhesive Layer 19

The adhesive layer 19 may be composed of, for instance, a publicly known acrylic adhesive, a publicly known silicone adhesive, or a publicly known rubber adhesive.

The components of the metal-air battery 1 are made of the aforementioned materials. Using these materials causes, for instance, a reaction between zinc within the negative-electrode active material layer 16 and hydroxide ions within the electrolytic solution, thus generating a zinc hydroxide in the negative electrode (i.e., the negative-electrode active material layer 16 and the negative-electrode current collector 17). Electrons emitted as a result of this generation are supplied from the negative electrode to the positive electrode (i.e., the positive-electrode catalyst layer 14 and the positive-electrode current collector 13). The generated zing hydroxide is decomposed into a zinc oxide and water, and the water returns to the electrolytic solution. In the positive electrode by contrast, water from the electrolytic solution, an oxygen gas from the atmosphere, and electrons from the negative electrode react with each other on the catalyst contained in the positive-electrode catalyst layer 14, thus causing a discharge reaction by which hydroxide ions (OH-) are generated. As such, a discharge reaction progresses at the three-phase interface where oxygen (vapor phase), water (liquid phase), and an electron conductor (solid phase) coexist in the positive electrode. The hydroxide ions conduct through the electrolytic solution to reach the negative electrode. The metal-air battery 1 achieves continuous extraction of power through such a cycle.

### 1.3. Method for Manufacturing Metal-Air Battery 1

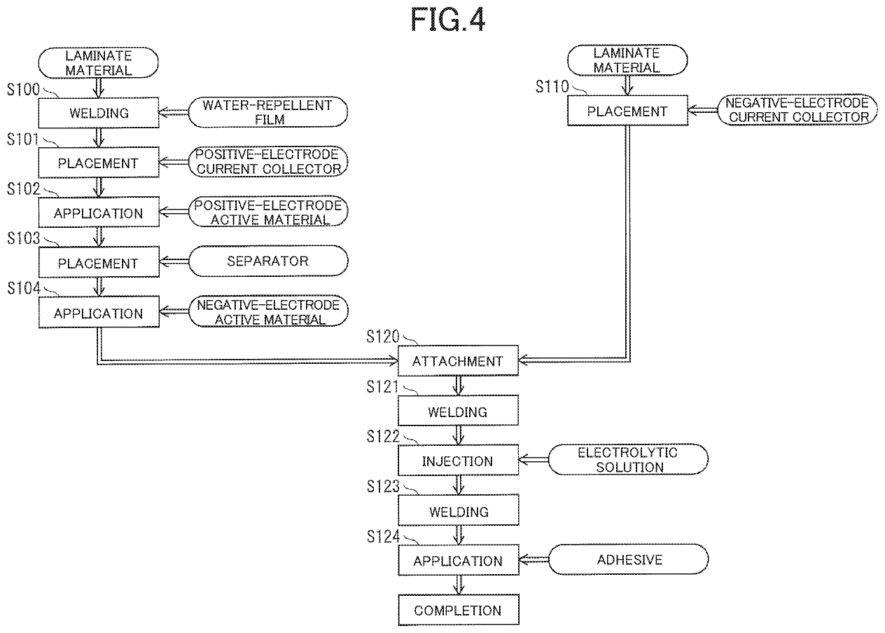

An example method for manufacturing the metal-air battery 1 will be described with reference to FIGS. 4 to 9.

FIG. 4 is a flowchart showing process steps for manufacturing the metal-air battery 1.

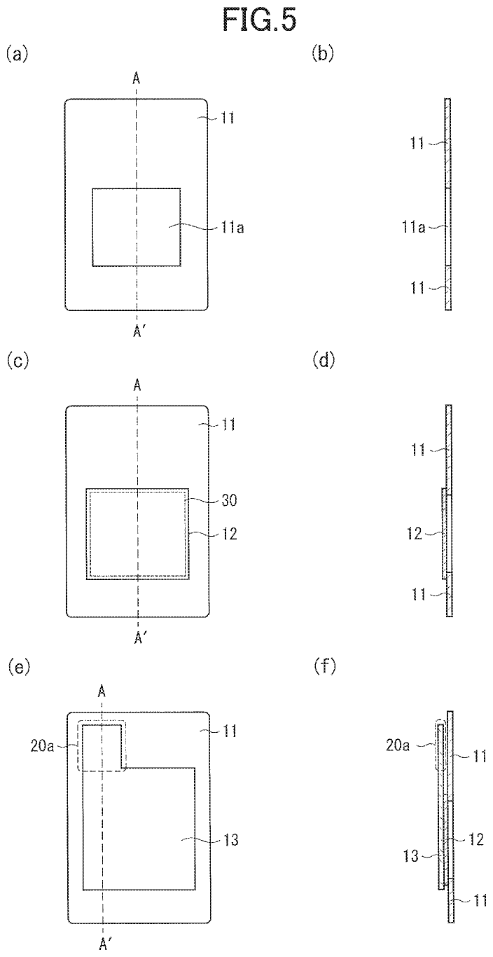

S100 is a step of preparing the laminate material 11 having the opening 11a, as illustrated in FIGS. 5(a) and (b), followed by placing the water-repellent film 12 onto the laminate material 11 so as to cover the opening 11a, as illustrated in FIGS. 5(c) and (d), followed by thermally welding the laminate material 11 and the water-repellent film 12 together at a welding portion 30 located at the edge of the opening 11a. Each side of the welding portion 30 has a predetermined width; the broken lines denoted by the reference numeral 30 in FIG. 5(c) indicate the center lines of the individual sides of the welding portion 30.

FIG. 5(a) illustrates the metal-air battery 1 at some midpoint of manufacture viewed from the second surface. FIG. 5(b) is a cross-sectional view taken along line A-A′ in FIG. 5(a). FIG. 5(c) illustrates the metal-air battery 1 at some midpoint of manufacture viewed from the second surface. FIG. 5(d) is a cross-sectional view taken along line A-A′ in FIG. 5(c).

S101 is a step of placing the positive-electrode current collector 13 onto the water-repellent film 12, as illustrated in FIGS. 5(e) and (f). As earlier described, part of the positive-electrode current collector 13 extends upward in the drawing to form the positive-electrode lead 20a. FIG. 5(e) illustrates the metal-air battery 1 at some midpoint of manufacture viewed from the second surface. FIG. 5(f) is a cross-sectional view taken along line A-A′ in FIG. 5(e).

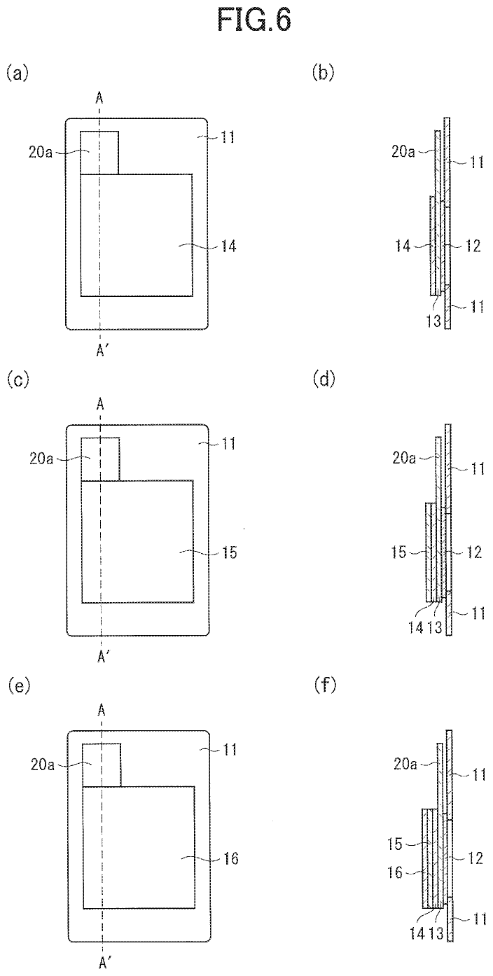

S102 is a step of applying a paste containing the aforementioned material of the positive-electrode catalyst layer 14 onto the positive-electrode current collector 13, followed by drying the positive-electrode current collector 13 to form the positive-electrode catalyst layer 14, as illustrated in FIGS. 6(a) and (b). FIG. 6(a) illustrates the metal-air battery 1 at some midpoint of manufacture viewed from the second surface. FIG. 6(b) is a cross-sectional view taken along line A-A′ in FIG. 6(a).

S103 is a step of placing a nonwoven fabric made of the aforementioned material of the separator 15 as an electrolytic layer, onto the positive-electrode catalyst layer 14, as illustrated in FIGS. 6(c) and (d). FIG. 6(c) illustrates the metal-air battery 1 at some midpoint of manufacture viewed from the second surface. FIG. 6(d) is a cross-sectional view taken along line A-A′ in FIG. 6(c).

S104 is a step of applying a paste containing the aforementioned material of the negative-electrode active material layer 16 onto the electrolytic layer (separator 15), as illustrated in FIGS. 6(e) and (f). FIG. 6(e) illustrates the metal-air battery 1 at some midpoint of manufacture viewed from the second surface. FIG. 6(f) is a cross-sectional view taken along line A-A′ in FIG. 6(e).

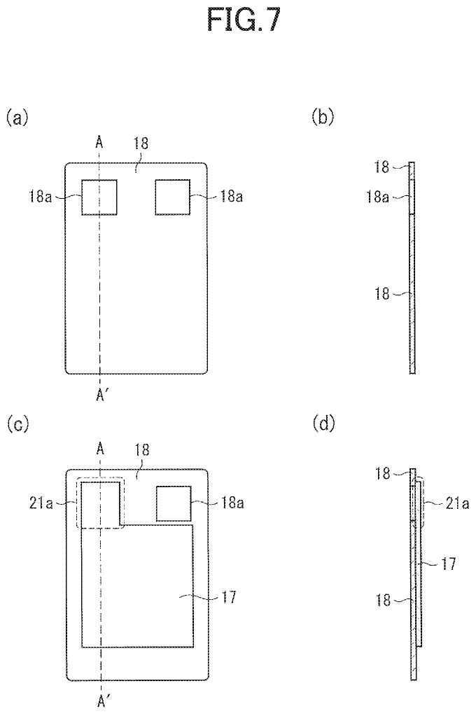

S110 is a step of preparing the laminate material 18 having the two openings 18a, as illustrated in FIGS. 7(a) and (b), followed by placing the negative-electrode current collector 17 onto the laminate material 18 so as to cover one of the openings 18a, as illustrated in FIGS. 7(c) and (d). As earlier described, part of the negative-electrode current collector 17 extends upward in the drawing to form the negative-electrode lead 21a. FIG. 7(a) illustrates the metal-air battery 1 at some midpoint of manufacture viewed from the first surface. FIG. 7(b) is a cross-sectional view taken along line A-A′ in FIG. 7(a). FIG. 7(c) illustrates the metal-air battery 1 at some midpoint of manufacture viewed from the first surface. FIG. 7(d) is a cross-sectional view taken along line A-A′ in FIG. 7(c).

S120 is a step of joining together the laminate material 11 after Steps S100 to S104 and the laminate material 18 after Step S110 in such a manner that the negative-electrode active material layer 16 on the laminate material 11 and the negative-electrode current collector 17 on the laminate material 18 face each other. At this time, the positive-electrode lead 20a of the positive-electrode current collector 13 is disposed in a location that does not overlap the negative-electrode current collector 17 including the negative-electrode lead 21a when viewed from the second surface. In addition, the negative-electrode lead 21a of the negative-electrode current collector 17 is disposed in a location that does not overlap the positive-electrode current collector 13 including the positive-electrode lead 20a when viewed from the second surface. Furthermore, one of the two openings 18a of the laminate material 18 is disposed in a location that overlaps the positive-electrode lead 20a when viewed from the second surface, and the other opening 18a is disposed in a location that overlaps the negative-electrode lead 21a when viewed from the second surface. Thus, when the laminate material 18 is viewed from the second surface, the positive-electrode terminal 20 is exposed from one of the two openings 18a, and the negative-electrode terminal 21 is exposed from the other opening 18a.

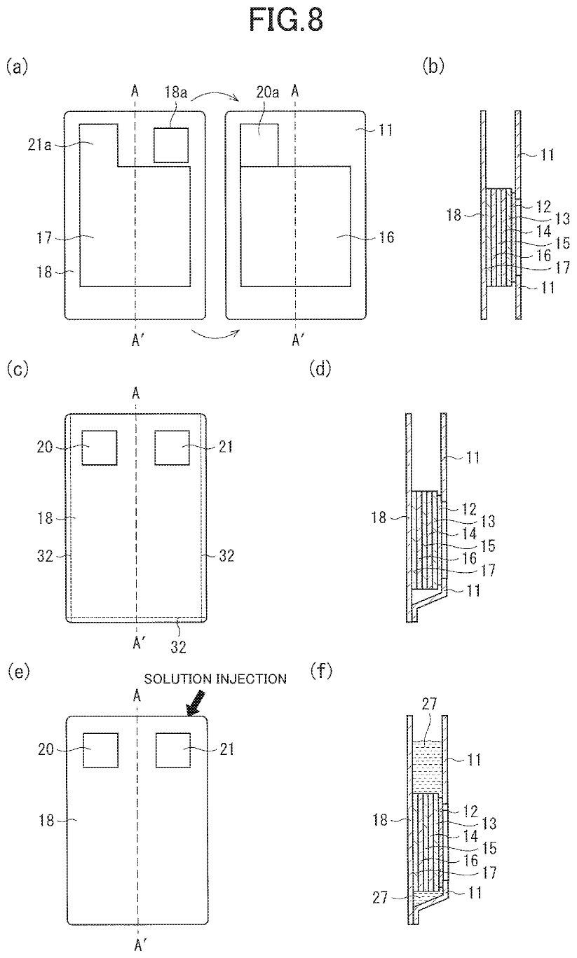

FIG. 8(a) illustrates joining together of the laminate material 11 after Steps S100 to S104 and the laminate material 18 after Step S110. FIG. 8(b) is a cross-sectional view taken along line A-A′ in FIG. 8(a) after the joining.

S121 is a step of thermally welding together the laminate materials 11 and 18 at welding portions 32 on three sides in the lower part and both ends of the laminate materials 11 and 18, as illustrated in FIGS. 8(c) and (d). Each side of the welding portions 32 has a predetermined width; the broken lines denoted by the reference numeral 32 in FIG. 8(c) indicate the center lines of the individual sides of the welding portions 32. FIG. 8(c) illustrates the metal-air battery 1 at some midpoint of manufacture viewed from the second surface. FIG. 8(d) is a cross-sectional view taken along line A-A′ in FIG. 8(c).

S122 is a step of injecting an electrolytic solution 27 from the non-welded side into the laminate materials 11 and 18, which are now in the form of a bag after the thermal welding on the three sides, as illustrated in FIGS. 8(e) and (f). The electrolytic solution 27 penetrates the electrolytic layer (separator 15). FIG. 8(e) illustrates the metal-air battery 1 at some midpoint of manufacture viewed from the second surface. FIG. 8(f) is a cross-sectional view taken along line A-A′ in FIG. 8(e).

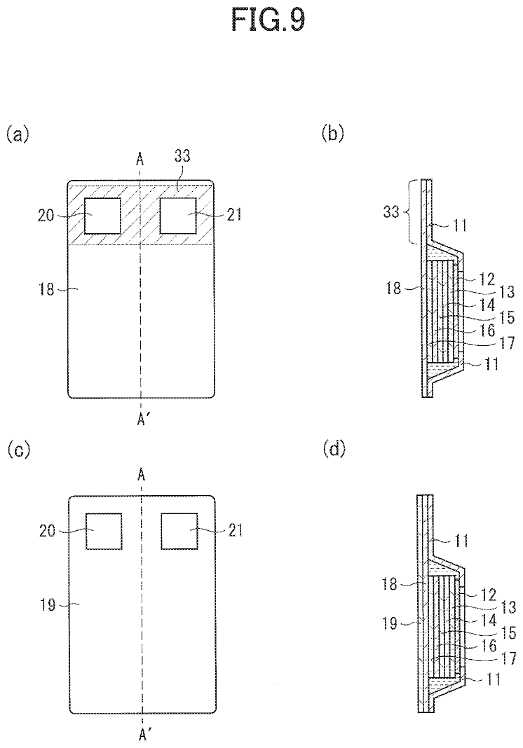

S123 is a step of thermally welding together the laminate materials 11 and 18 at a welding portion 33 on the non-welded side of the laminate materials 11 and 18, which are now in the form of a bag injected with the electrolytic solution 27, as illustrated in FIGS. 9(a) and (b), in order for the electrolytic solution 27 not to leak from the openings 18a of the laminate material 18, from which the positive-electrode terminal 20 and the negative-electrode terminal 21 are exposed. The welding portion 33 is a hatched region in FIG. 9(a) for instance. FIG. 9(a) illustrates the metal-air battery 1 at some midpoint of manufacture viewed from the second surface. FIG. 9(b) is a cross-sectional view taken along line A-A′ in FIG. 9(a).

S124 is a step of applying an adhesive-containing paste onto a surface of the laminate material 18 adjacent to the second surface to form the adhesive layer 19, as illustrated in FIGS. 9(c) and (d). FIG. 9(c) illustrates the metal-air battery 1 at some midpoint of manufacture viewed from the second surface. FIG. 9(d) is a cross-sectional view taken along line A-A′ in FIG. 9(c).

The metal-air battery 1 according to this disclosure is manufactured through the foregoing process steps.

### 1.4. Summary

According to the present disclosure, the positive-electrode terminal 20 and the negative-electrode terminal 21 do not protrude from the casing of the metal-air battery 1, and are exposed from the openings 18a of the joint surface (i.e., the laminate material 18 and the adhesive layer 19). Only joining the joint surface to a target object with the positive-electrode terminal 20 and negative-electrode terminal 21, which are exposed from the openings 18a of the joint surface, facing a terminal of the target object can establish electrical conduction with the target object. In addition, the joint surface, which is provided with the adhesive layer 19, is easily attached to the target object without soldering, welding, or other joining methods. In addition, the positive-electrode terminal 20 and the negative-electrode terminal 21 are not exposed from a surface (laminate material 11) opposite to the joint surface. This prevents a possible short circuit caused by accidental conductor contact after the attachment.

### 2. Second Embodiment

A metal-air battery 2 according to a second embodiment will be described with reference to the drawings. Components similar to those of the metal-air battery 1 according to the first embodiment will be denoted by the same reference signs.

### 2.1. Configuration of Metal-Air Battery 2

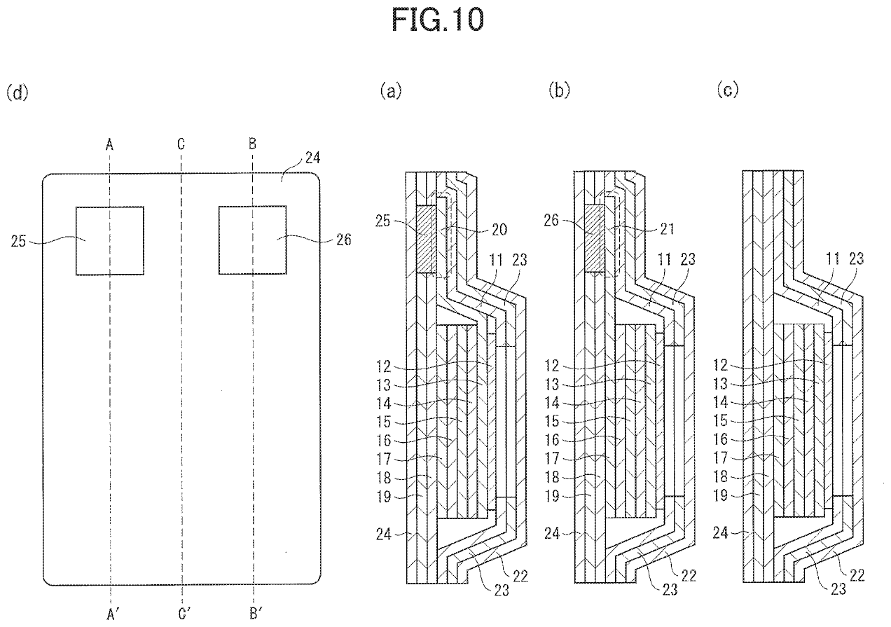

FIG. 10 illustrates the configuration of the metal-air battery 2. FIG. 10(a) is a cross-sectional view taken along line A-A′ in FIG. 10(d); FIG. 10(b), a cross-sectional view taken along line B-B′ in FIG. 10(d); FIG. 10(c), a cross-sectional view taken along line C-C′ in FIG. 10(d); and FIG. 10(d), a front view of the second surface of the metal-air battery 2.

The inner structure of the metal-air battery 2 is similar to that of the metal-air battery 1 according to the first embodiment and will not be elaborated upon. The metal-air battery 2 has a first surface provided with an adhesive layer 23 and protective layer 22 further stacked on the first surface of the metal-air battery 1 according to the first embodiment. The second surface of the metal-air battery is structured, in the second surface of the metal-air battery 1 according to the first embodiment, such that conductive adhesive layers 25 and 26 are disposed on the positive-electrode terminal 20 and the negative-electrode terminal 21, which are exposed from the two openings 18a, and such that a protective layer 24 is stacked on a surface of the adhesive layer 19 and surfaces of the conductive adhesive layers 25 and 26.

### 2.2. Materials of Metal-Air Battery 2

### (1) Protective Layers 22 and 24

The protective layer 22 is used for preventing the progress of a discharge reaction within the metal-air battery 2, and is made of material having low breathability. Referring to breathability, the protective layer 22 is required to have an oxygen transmission rate of 1 ml/m²/day/atm or less based on JIS K7126-2, “Plastics—Film and Sheet—Method of Testing Gas-Transmission Rate”.

The protective layer 24 is used in order for the adhesive layer 19 not to adhere to the outside accidentally, and is made of material having low adhesion.

The protective layers 22 and 24 can be made of polyethylene terephthalate, or of paper having a surface coated with, for instance, polyethylene or modified polyvinyl alcohol in the form of resin. To enhance the peeling capability between the protective layers 22 and 24 and the adjacent adhesive layers 19 and 23, a silicone or non-silicone peeling agent may be applied on the resin coats.

### (2) Adhesive Layer 23

The adhesive layer 23 can be made of the same material as the adhesive layer 19.

### (3) Conductive Adhesive Layers 25 and 26

The conductive adhesive layers 25 and 26 can be composed of, for instance, an acrylic adhesive containing a conductive filler, such as carbon powders.

### 2.3. Method for Manufacturing Metal-Air Battery 2

A method for manufacturing the metal-air battery 2 will be described.

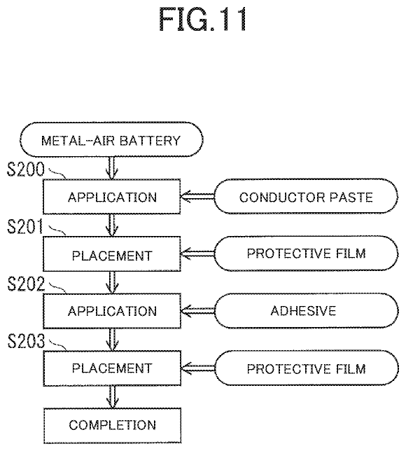

FIG. 11 is a flowchart showing process steps for manufacturing the metal-air battery 2.

S200 is a step of preparing the metal-air battery 2 according to the second embodiment, followed by applying a conductive adhesive containing the aforementioned material of the conductive adhesive layers 25 and 26 to the two respective openings of the second surface (i.e., the adhesive layer 19 and the laminate material 18) of the metal-air battery 2 to thus form the conductive adhesive layers 25 and 26, as illustrated in FIG. 10(a), (b), and (d).

S201 is a step of placing a protective film made of the aforementioned material of the protective layer 24 onto the second surface (i.e., the adhesive layer 19 and the conductive adhesive layers 25 and 26) of the metal-air battery 2, which is now provided with the conductive adhesive layers 25 and 26, to thus form the protective layer 24.

S202 is a step of applying an adhesive-containing paste onto the first surface of the metal-air battery 2 except the opening 11a, where the water-repellent film 12 is exposed, to thus form the adhesive layer 23.

S203 is a step of placing a protective film made of the aforementioned material of the protective layer 22 onto the first surface of the metal-air battery 2, which is now provided with the adhesive layer 23, to thus form the protective layer 22.

The metal-air battery 2 is manufactured through the foregoing process steps.

### 2.4. Summary

The metal-air battery 2 according to the second embodiment features the protective layer 22 disposed on the first surface in a peelable manner. Consequently, the positive electrode (i.e., the positive-electrode current collector 13 and the positive-electrode catalyst layer 14) is not exposed to the atmosphere from after the production of the metal-air battery 2 until the peeling of the protective layer 22, thus preventing the progress of a discharge reaction in the metal-air battery 2.

The metal-air battery 2 according to the second embodiment features the protective layer 24 disposed on the second surface in a peelable manner. This prevents the metal-air battery 2 from accidentally adhering to an external object from after the production of the metal-air battery 2 until the peeling of the protective layer 24, thus enhancing workability and facilitating handling.

The metal-air battery 2 according to the second embodiment includes the conductive adhesive layer 25 in the opening of the second surface where the positive-electrode terminal 20 is exposed, and includes the conductive adhesive layer 26 in the opening of the second surface where the negative-electrode terminal 21 is exposed. This facilitates establishment of an electrical contact between the positive-electrode terminal 20 and negative-electrode terminal 21 of the metal-air battery 2 and a terminal of a target object.

### 3. Third Embodiment

A metal-air battery 3 according to a third embodiment will be described with reference to the drawings. Components similar to those of the metal-air battery 1 according to the first embodiment will be denoted by the same reference signs.

### 3.1. Configuration of Metal-Air Battery 3

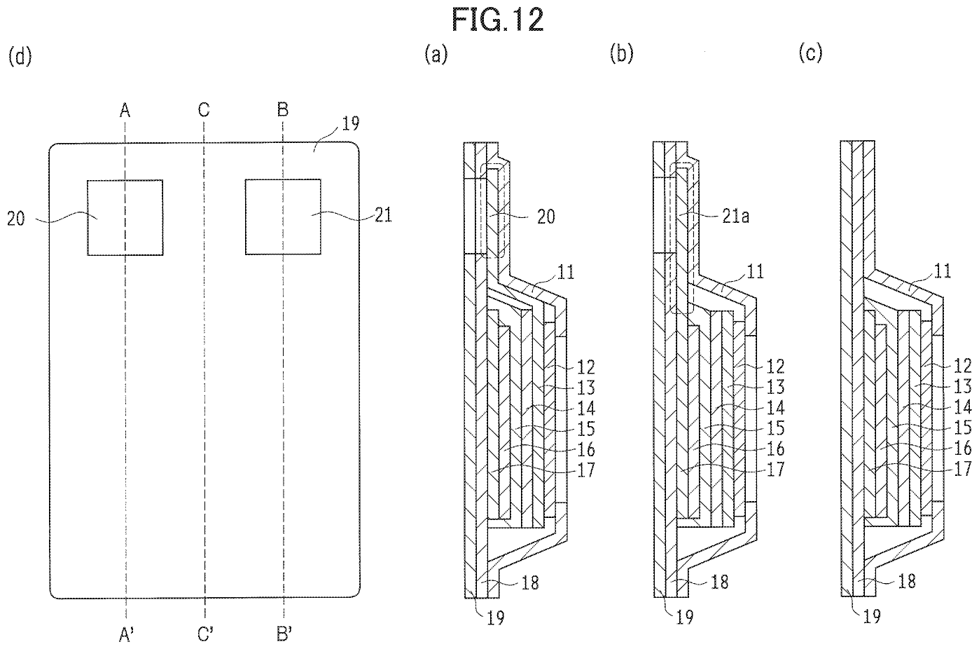

FIG. 12(a) is a cross-sectional view taken along line A-A′ in FIG. 12(d); FIG. 12(b), a cross-sectional view taken along line B-B′s in FIG. 12(d); FIG. 12(c), a cross-sectional view taken along line C-C′ in FIG. 12(d); and FIG. 12(d), a front view of the second surface of the metal-air battery 3.

The inner structure of the metal-air battery 3 is different from that of the metal-air battery 1 according to the first embodiment in terms of the placement of the separator 15. The inside of the metal-air battery 3 according to the third embodiment is structured such that the separator 15 covers the edges of the negative-electrode active material layer 16 and negative-electrode current collector 17 and are stacked in contact with the laminate material 18, as illustrated in FIGS. 12(a) to (c). The separator 15 also covers part of the negative-electrode lead 21a, as illustrated in FIG. 12(b).

The separator 15 covers the edges of the negative-electrode active material layer 16 and negative-electrode current collector 17 while leaving part of the negative-electrode lead 21a uncovered, thus preventing a short circuit between the positive and negative electrodes when compared to a configuration where these edges are exposed.

### 4. Fourth Embodiment

A metal-air battery 4 according to a fourth embodiment will be described with reference to the drawings. Components similar to those of the metal-air batteries 1 to 3 according to the first to third embodiments will be denoted by the same reference signs.

### 4.1. Configuration of Metal-Air Battery 4

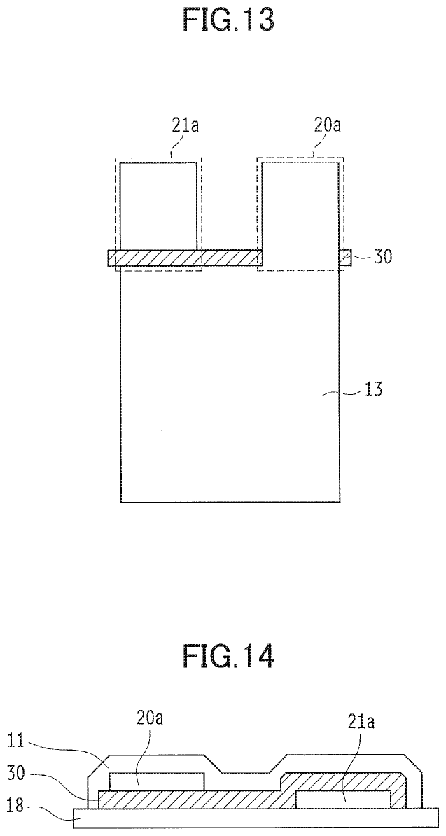

The metal-air battery 4 according to the fourth embodiment further includes an insulating tape 30 stacked between the positive-electrode current collector 13 and the negative-electrode current collector 17 so as to overlap part of the positive-electrode lead 20a and negative-electrode lead 21a. FIG. 13 is a plan view of the positive-electrode current collector 13, negative-electrode current collector 17 and insulating tape 30 extracted from the metal-air battery 4 and viewed from the positive-electrode current collector 13. FIG. 14 is a cross-sectional view of the metal-air battery 4 along the longer-side direction of the insulating tape 30.

As illustrated in FIG. 13, the insulating tape 30 is continuously provided so as to overlap part of the negative-electrode lead 21a and positive-electrode lead 20a, and to lie between the negative-electrode lead 21a and the positive-electrode lead 20a. However, where the insulating tape 30 is disposed does not overlap first and second openings 18a of the laminate material 18. In the metal-air battery 4 including the insulating tape 30 placed as described above, the insulating tape 30 is disposed between the laminate material 18 and the positive-electrode lead 20a and between the laminate material 11 and the negative-electrode lead 21a, as illustrated in FIG. 14.

The metal-air battery 4 is manufactured through the following process steps: stacking the insulating tape 30 in a predetermined location on the negative-electrode current collector 17 placed on the laminate material 18 shown in FIGS. 7(c) and (d); and joining the laminate material 18 with the insulating tape 30 stacked thereupon to the laminate material 11 shown in FIGS. 6(e) and (f). It is noted that the insulating tape 30 may be stacked firstly on the laminate material 11 shown in FIGS. 6(e) and (f).

As described above, the insulating tape 30 is placed between the laminate material 18 and the positive-electrode lead 20a, between the laminate material 11 and the negative-electrode lead 21a, and between the positive-electrode lead 20a and the negative-electrode lead 21a. This placement maintains insulation between the negative-electrode lead 21a and the positive-electrode lead 20a, thus preventing a short circuit between these leads.

The insulating tape 30 is preferably made of material that is chemically stable in an electrolytic solution to be used, and that is selected from among materials that are weldable to the laminate materials 11 and 18. For an alkali electrolytic solution, the insulating tape 30 is made of olefin resin, butyl rubber, or other materials.

### 5. Fifth Embodiment

The metal-air batteries 1 to 4 according to the first to fourth embodiments may have their first surfaces provided with characters, pictures or other things printed. The metal-air batteries 1 to 4 can accordingly not only supply power, but also transmit information using characters or pictures.

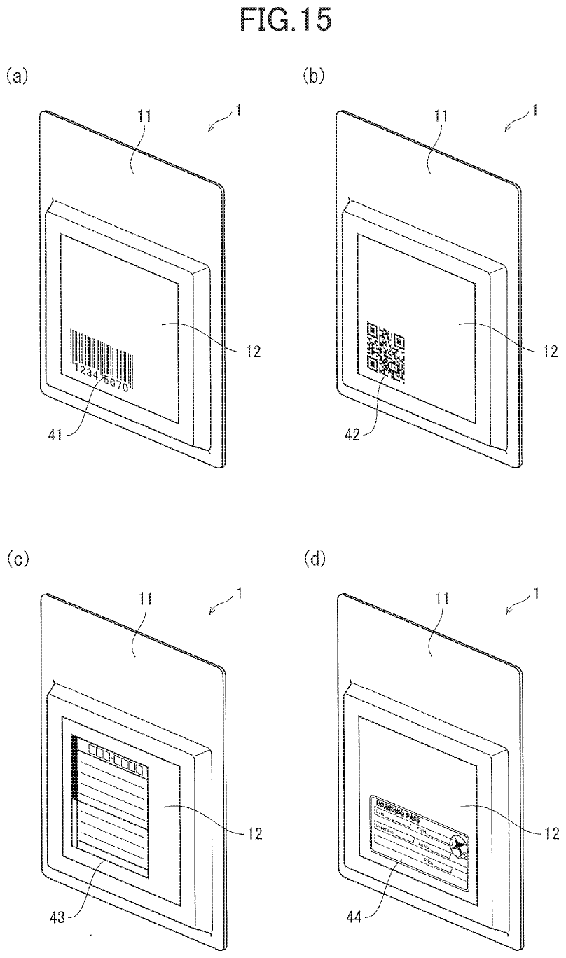

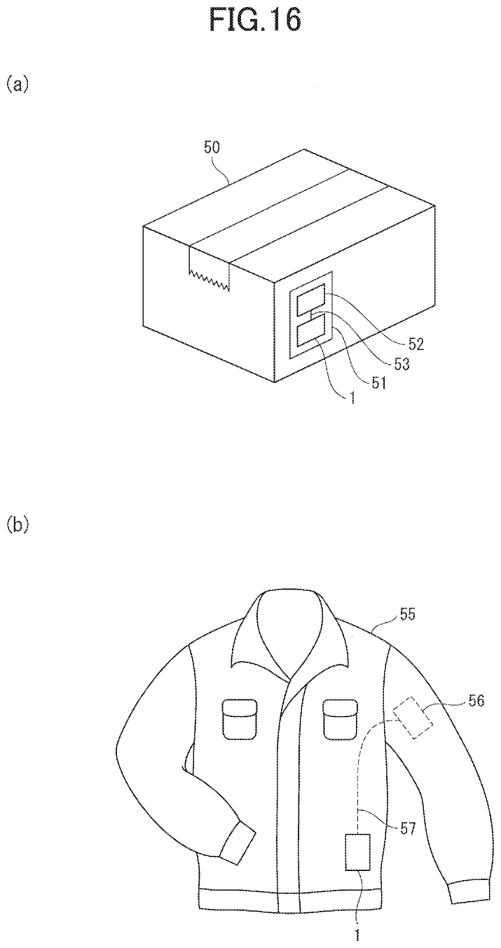

For instance, a bar code 41 may be printed on the first surface of the metal-air battery 1, as illustrated in FIG. 15(a). For instance, printing a bar code indicating the proper number of the metal-air battery 1 facilitates control of the manufactured metal-air battery 1. Moreover, printing a bar code indicating the proper number of a target object to which the metal-air battery 1 supplies power facilitates control of the target object.

Alternatively, a two-dimensional code 42 may be printed on the first surface of the metal-air battery 1, as illustrated in FIG. 15(b). Printing a two-dimensional code can provide uniform-resource-locator (URL) information for instance. Accordingly, only attaching the metal-air battery 1 having a small area to a target object enables, for instance, a large volume of advertisement information about the target object to be transmitted through the URL.

Alternatively, a slip 43 may be printed on the first surface of the metal-air battery 1, as illustrated in FIG. 15(c). Alternatively, a ticket 44, such an airplane boarding ticket, may be printed on the first surface of the metal-air battery 1, as illustrated in FIG. 15(d). Accordingly, the metal-air battery 1 can function as a ticket or slip as well as a power supplier to a target object.

Although FIGS. 15(a), (b), (c), and (d) illustrate an instance where a bar code, a two-dimensional code, a slip, or a ticket is printed on the water-repellent film 12, which is exposed to the first surface of the metal-air battery 1, a bar code, a two-dimensional code, a slip, a ticket, or other things may be printed on the laminate material 11.

Alternatively, a sticker or other things with, for instance, a bar code, two-dimensional code, slip or ticket printed thereon may be attached to the laminate material 11 or the water-repellent film 12.

### 6. Sixth Embodiment

The following describes expected situations where the metal-air battery 1 according to the first embodiment is used.

In some cases, to control the quality of a delivery package, a delivery company delivers the package with a tag incorporating sensors (e.g., a thermometer and a hygrometer) being attached thereto. The metal-air battery 1 can be used in the following manner in these cases: the metal-air battery 1 is attached to a tag 51 on the package 50, thus supplying power to a sensor 52 via a power-source cable 53 built in the tag 51, as illustrated in FIG. 16(a).

Further, a wearable vital-sign sensor or other sensors has been recently developed that is capable of measuring, for instance, the pulse rate and blood pressure of a person wearing an item of clothing incorporating a sensor that measures pulse rate, blood pressure, and other things. The metal-air battery 1 can be used in the following manner in such a case: the metal-air battery 1 is attached to a clothing item 55 incorporating a sensor 56, thus supplying power to a sensor 56 via a power-source cable 57 built in the clothing item 55, as illustrated in FIG. 16(b).

### CROSS-REFERENCE TO RELATED APPLICATION

This international application claims priority to Japanese Patent Application No. 2018-079722, filed Apr. 18, 2018, the content of which is hereby incorporated by reference in its entirety.

1-16. (canceled)

17. A metal-air battery comprising:
a casing including a first surface having breathability and second surface different from the first surface; and
a positive electrode housed in the casing,
a negative electrode housed in the casing,
a positive-electrode terminal electrically connected to the positive electrode and exposed from the casing,
a negative-electrode terminal electrically connected to the negative electrode and exposed from the casing, and
an adhesive layer containing an adhesive and provided on a portion of the second surface.

18. The metal-air battery according to claim 17, wherein
the second surface comprises an opening disposed in a location corresponding to the positive-electrode terminal or the negative-electrode terminal,
the adhesive layer is provided on the portion of the second surface except the opening.

19. The metal-air battery according to claim 17, wherein
the second surface comprises
a first opening disposed in a location corresponding to the positive-electrode terminal, and
a second opening disposed in a location corresponding to the negative-electrode terminal, and
the adhesive layer is provided on the portion of the second surface except the first and second openings.

20. The metal-air battery according to claim 19, wherein
the positive-electrode terminal and the negative-electrode terminal being disposed in a location where the positive-electrode terminal and the negative-electrode terminal do not overlap each other when viewed from the second surface.

21. The metal-air battery according to claim 17, wherein
the positive electrode is adjacent to the first surface within the casing,
the negative electrode is adjacent to the second surface within the casing, and
the metal-air battery further comprises an electrolytic layer between the positive and negative electrodes, the electrolytic layer containing an electrolyte.

22. The metal-air battery according to claim 17, wherein
the casing includes
a first resin sheet including the first surface, and
a second resin sheet including the second surface and joined to the first resin sheet.

23. The metal-air battery according to claim 22, wherein
the negative electrode has
a negative-electrode current collector stacked on the second resin sheet, and
a negative-electrode active material layer stacked on the negative-electrode current collector and containing a negative-electrode active material, and
the negative-electrode current collector includes a negative-electrode lead composed of a part of the negative-electrode current collector extending to form the negative-electrode terminal.

24. The metal-air battery according to claim 23, wherein the electrolytic layer covers an edge of the negative-electrode active material.

25. The metal-air battery according to claim 22, wherein
the positive electrode has
a positive-electrode catalyst layer stacked on the electrolytic layer and containing a catalyst capable of oxygen reduction, and
a positive-electrode current collector stacked on the positive-electrode catalyst layer, and
the positive-electrode current collector includes a positive-electrode lead composed of a part of the positive-electrode current collector extending to form the positive-electrode terminal.

26. The metal-air battery according to claim 25, wherein
the first resin sheet has a third opening, and
the positive electrode comprises a water-repellent film stacked on the positive-electrode current collector and sealing the third opening from an inside of the third opening.

27. The metal-air battery according to claim 22, further comprising:
a positive-electrode lead composed of a part of the positive electrode extending to form the positive-electrode terminal;
a negative-electrode lead composed of a part of the negative electrode extending to form the negative-electrode terminal; and
an insulating tape disposed between the first resin sheet and the negative-electrode lead, between the second resin sheet and the positive-electrode lead, and between the positive-electrode lead and the negative-electrode lead.

28. The metal-air battery according to claim 17, wherein the first surface comprises a surface on which a protective layer having no breathability is disposed in a peelable manner.

29. The metal-air battery according to claim 17, wherein the adhesive layer on the surface of the second surface comprises a surface on which a protective layer having no adhesion is disposed in a peelable manner.

30. The metal-air battery according to claim 17, wherein at least a part of the first surface is made of a porous insulating material.

31. The metal-air battery according to claim 19, wherein the first and second openings incorporate a conductive adhesive layer.

32. The metal-air battery according to claim 17, wherein the first surface is provided with a character or picture displayed.

33. The metal-air battery according to claim 32, wherein the picture is a bar code or a two-dimensional code.

34. An information display plate comprising the metal-air battery according to claim 31.

35. A method for manufacturing a metal-air battery, comprising:
a first step of stacking a positive-electrode layer having a portion to be a positive-electrode terminal onto a first resin sheet having breathability;
a second step of stacking a negative-electrode layer having a portion to be a negative-electrode terminal onto a second resin sheet different from the first resin sheet;
a third step of joining together the first and second resin sheets with the positive-electrode layer on the first resin sheet and the negative-electrode layer on the second resin sheet facing each other via an electrolytic layer; and
a fourth step of stacking an adhesive layer onto a surface of the second resin sheet where the negative-electrode layer is not stacked,
wherein the portion to be the positive-electrode terminal and the portion to be the negative-electrode terminal are disposed in a location where the portion to be the positive-electrode terminal and the portion to be the negative-electrode terminal do not overlap each other when viewed from the second resin sheet.

36. The method for manufacturing a metal-air battery according to claim 35, wherein
the second resin sheet comprises
a first opening disposed in a location corresponding to the portion to be the positive-electrode terminal, and
a second opening disposed in a location corresponding to the portion to be the negative-electrode terminal.
